(19) United States
(12) Patent Application Publication
(10) Pub. No.: US 2018/0184141 A1
(43) Pub. Date: Jun. 28, 2018

(54) DEVICE, METHOD, AND PROGRAM FOR PROVIDING SUBSCRIPTION CONTENT TO MULTIPLE CLIENT DEVICES CONNECTED IN A HOME NETWORK

(71) Applicant: ARRIS Enterprises LLC, Suwanee, GA (US)

(72) Inventor: Krishna Prasad Panje, Bangalore (IN)

(21) Appl. No.: 15/392,643

(22) Filed: Dec. 28, 2016

(51) Int. Cl. H04N 21/2343; H04L 29/06; H04L 29/08; H04N 21/61; H04N 21/854; H04N 21/2187

(52) U.S. Cl. CPC H04N 21/234309; H04L 65/4084; H04L 67/02; H04L 67/04; H04L 67/42; H04N 21/6125; H04N 21/85406; H04N 21/2187; H04L 65/607

(57) ABSTRACT

An electronic apparatus, method, and algorithm provide subscription content to one or more client devices connected in a home network. The electronic apparatus, method, and algorithm receive A/V content from a content provider and information from the client devices, store the A/V content in a native format, and generate data for a directory, the directory listing information regarding the A/V content received from the content provider. The electronic apparatus, method, and algorithm publish the directory in a native data format, an agnostic data format, or a plurality of data formats; or publish the directory in a data format known to be compatible with the client devices based on the information received for the client devices. The electronic apparatus, method, and algorithm output the A/V content received from the content provider to the client devices based on a selection made from the directory.

### TECHNICAL FIELD

The present disclosure is related to electronic devices used for providing subscription content to home network devices using open industry standards.

### BACKGROUND

Consumer electronic devices are being used more and more in homes and in combination with other electronic devices such as a content media server, gateway device, and set-top box. The content media server, gateway device, and set-top box house electronic circuits that convert signals received from a content service provider into signals usable by consumer devices for displaying audio/video media content such a subscription television programming and movies. The content service providers include, for example, cable television providers, satellite television providers, internet service providers, and multiple system operators.

Per recent Federal Communication Commission (FCC) regulations, high definition (HD) content media servers, gateway devices and set-top boxes will be required to offer media sharing using an open industry standard for home networking. The FCC regulations for media sharing is covered under 76.640(b)(4)(iii). Presently, the Digital Living Network Alliance (DLNA) standard or Commercial Video Profile (CVP)-2 (i.e., VidiPath) standard is the only standard that meets all the criteria of FCC 76.640(b)(4)(iii) for openness.

Using the DLNA or CVP-2 (i.e., VidiPath) standard, the content media server, gateway device, and set-top box will publish content entries for tunable channels and media content for use by the client devices in a home network. These content entries are published as part of a CDS (Content Directory Service), which contains a list of user resource identifiers (URIs) to the content (e.g., channels/live or recorded content) available from the content media server, gateway device, and set-top box. The client devices (e.g., compatible DLNA or CVP-2 (i.e., VidiPath) game consoles, personal computers, tablets, appliances, televisions, mobile devices, etc.) can subscribe to the CDS and get the latest URIs to request the content through Hypertext Transfer Protocol (HTTP).

However, some of the client devices have problems displaying the content entries published as part of a CDS because the content types (i.e., data format types) are not directly playable on the devices (e.g., unsupported content type), thereby limiting the CDS publication to entries in the format supported by the client device. Thus, less capable client devices are deprived of a full list of the tunable channels and content listed in the CDS and provided by the content media server, gateway device, and set-top box.

Using conventional techniques, there is no effective way to provide a more complete CDS (i.e., with a full list of the tunable channels and content) from the content media server, gateway device, and set-top box to less capable client devices. Thus, it would be advantageous to be able to provide entries in a CDS for every possible content received and/or stored by a content media server, gateway device, and set-top box to all in-home DLNA or VidiPath client devices so that even the lesser capable DLNA or VidiPath client devices can receive a complete CDS (i.e., with a full list of the tunable channels and content) and thereby receive more subscription television programming and movie content.

### SUMMARY

In an embodiment described in the present application, an electronic apparatus provides subscription content to one or more client devices connected in a home network.

The electronic apparatus includes an input circuit that receives audio/video (A/V) content from a content provider and information from the one or more client devices; a memory for storing the A/V content received from the content provider in a native data format; and a controller that generates data for a directory, the directory listing information regarding the A/V content received from the content provider.

Additionally, the output circuit publishes the directory in the native data format, an agnostic data format or a plurality of data formats, or publishes the directory in a data format known to be compatible with the one or more client devices based on the information received from the one or more client devices. The directory is used by the one or more client devices for selecting A/V content. The output circuit further outputs the A/V content received from the content provider to the one or more client devices based on a selection made from the directory.

In an embodiment described in the present application, the electronic apparatus includes a transcoder circuit that: converts the data for the directory from the native data format of the content received from the content provider to the agnostic data format, the plurality of data formats, or the data format known to be compatible with the one or more client devices; and converts the A/V content received from the content provider from the native data format to the data format known to be compatible with the one or more client devices.

In an embodiment described in the present application, the A/V content output to the one or more client devices is content either stored in the memory or live-streamed from the content provider, and the directory is a content directory service or program guide containing a listing of user resource identifiers (URIs) for content available from the content provider through the electronic apparatus.

In an embodiment described in the present application, the controller: controls the output circuit to output the A/V content to an external server, the external server converting the A/V content from the native data format received from the content provider to the data format compatible with the one or more client devices; controls the input circuit to receive the A/V content converted by the external server; and controls the output circuit to output the A/V content in the data format known to be compatible with the one or more client devices.

In embodiments described in the present application, a method and algorithm are implemented for receiving A/V content from a content provider and information from the one or more client devices; storing the A/V content received from the content provider in a native data format; and generating data for a directory. The directory listing information regarding the A/V content received from the content provider.

In embodiments described in the present application, a method and algorithm are implemented for publishing the directory in the native data format, an agnostic data format or a plurality of data formats, or publishing the directory in a data format known to be compatible with the one or more client devices based on the information received from the one or more client devices. The directory is used by the one or more client devices for selecting A/V content. Additionally, the method and algorithm are implemented for outputting the A/V content received from the content provider to the one or more client devices based on a selection made from the directory.

In embodiments described in the present application, a method and algorithm are implemented for converting the data for the directory from the native data format of the content received from the content provider to the agnostic data format, the plurality of data formats, or the data format known to be compatible with the one or more client devices; and converting the A/V content received from the content provider from the native data format to the data format known to be compatible with the one or more client devices.

In an embodiment described in the present application, the method and algorithm are implemented for: outputting the A/V content to an external server, the external server converting the A/V content from the native data format received from the content provider to the data format compatible with the one or more client devices; receiving the A/V content converted by the external server; and outputting the A/V content in the data format known to be compatible with the one or more client devices.

In an embodiment described in the present application, a non-transitory computer-readable recording medium has recorded thereon a program embodying the features of the method/algorithm discussed above.

### BRIEF DESCRIPTION OF THE DRAWINGS

FIG. 1 is a block diagram showing an exemplary system for providing subscription content to one or more client devices connected in a home network according to the present invention;

FIG. 2 is a block diagram showing an exemplary gateway device for providing subscription content to one or more client devices connected in a home network according to the present invention;

FIG. 3 is flow chart showing an exemplary algorithm and method for providing subscription content to one or more client devices connected in a home network according to the present invention; and

FIG. 4 is flow chart showing an exemplary algorithm and method for providing subscription content to one or more client devices connected in a home network according to the present invention.

### DETAILED DESCRIPTION

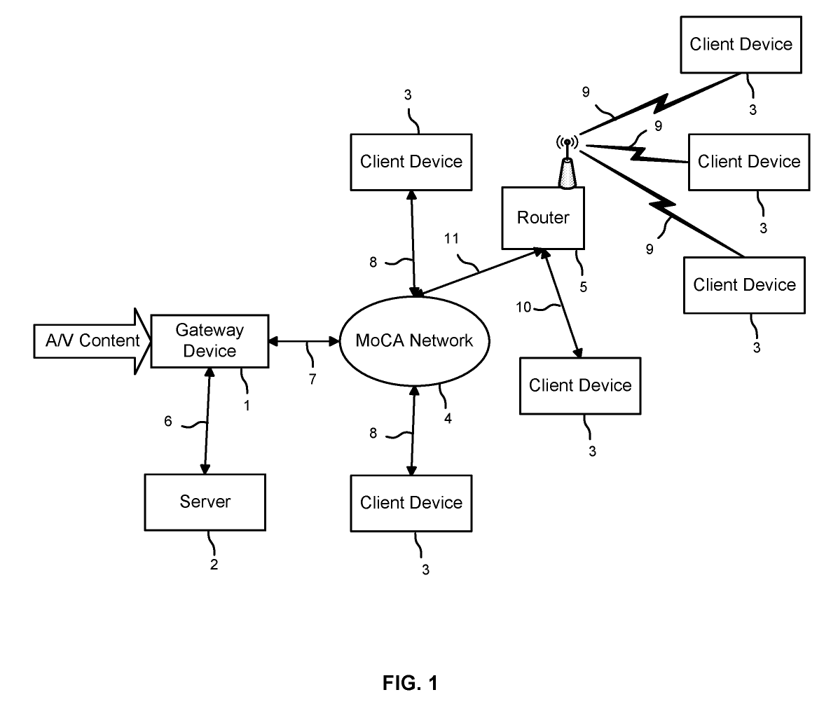

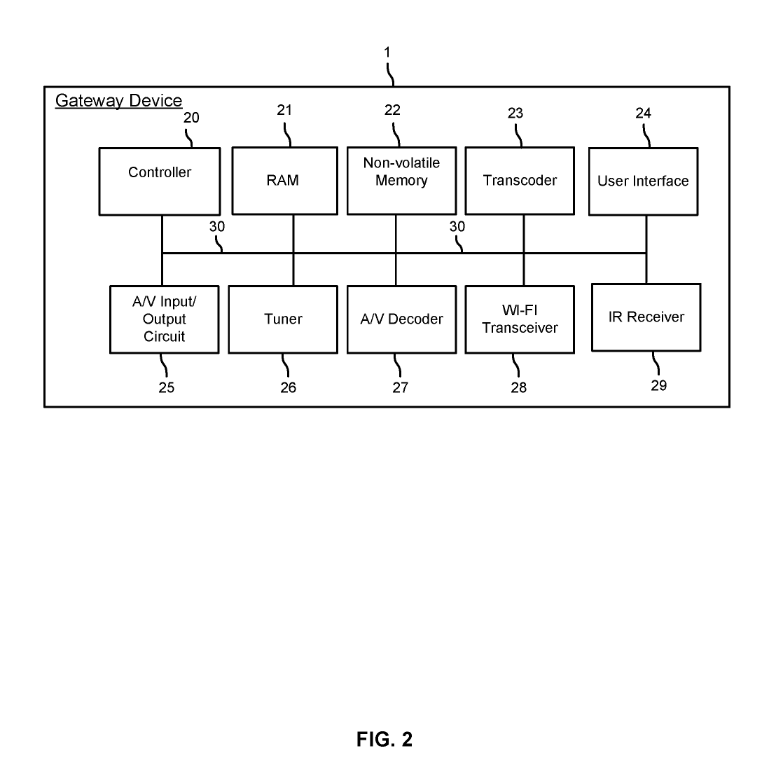

FIG. 1 is a block diagram showing an exemplary system for providing subscription content to one or more client devices connected in a home network according to the present invention. As shown in FIG. 1, the system includes a gateway device 1, a server 2, a MoCA network 4, a router 5 and client devices 3. For ease of discussion, FIG. 2 refers to a stand-alone gateway device 1, but the present disclosure is not intended to be limited only to this type of device and alternatively the gateway device 1 can be integrated directly into a consumer device such as a television, computer, or other consumer device, such as electronically equipped appliances. Additionally, a set-top box, digital media server or other similar device, which includes electronic circuits capable of converting signals received from a service provider into signals usable by consumer devices for displaying audio/video (A/V) content such a subscription television programming and movies, can be used in place of the gateway device 1. The service provider includes, for example, a cable television provider, a satellite television provider, an internet service provider, and multiple system operators.

The gateway device 1 houses components and circuits (e.g., as shown in FIG. 2) that receive, store, convert, and transmit the A/V content received from a content service provider. The content service provider may include cable television providers, satellite television providers, internet service providers, and multiple system operators; and the A/V content may include television programming and movies. The gateway device 1 provides information related to the A/V content as well as the A/V received and stored by the gateway 1 to the client devices 3 via the MoCA network 4 and router 5.

The information related to the A/V content may include content entries published as part of a CDS (Content Directory Service), which contains a list of user resource identifiers (URIs) to the content (e.g., channels/live or recorded content) available from the gateway device 1. The information related to the A/V content may also include data format capability information received in an HTTP GET or HEAD request transmitted between the gateway device 1 and client devices 3. The content capability information is information that can be used by the gateway 1 for determining the format of the A/V content that can be processed by client devices 3. The operation of the components and circuits of the gateway device 1 will be discussed in more detail with reference to FIG. 2.

The server 2 includes similar components and circuits of the gateway device 1 (as described with reference to FIG. 2) so as to be capable of receiving, decoding and converting the A/V content received from the gateway device 1. The server 2 communicates with the gateway device 1 using a communication connection 6 between the devices. The communication connection 6 between the server 2 and the gateway device 1 may include, for example, a coaxial cable connection, a digital media interface (DMI), high-definition multimedia interface (HDMI) or other audio/video interface for transferring video data and digital audio data from an HDMI-compliant source device. Although the communication connection 6 is described as a wired connection, the communication connection 6 may also be a wireless connection that operates in accordance with, but is not limited to, IEEE802.11 protocol, a Radio Frequency For Consumer Electronics (RF4CE) protocol, ZigBee protocol, and/or IEEE802.15.4 protocol.

The MoCA network 4 is a coaxial cable network that is used as an extension of the existing home network onto the coaxial cable network that is compliant with, for example, a MoCA 1 or 2 standard protocol. MoCA is an acronym for the Multimedia Over Coax Alliance. The MoCA network is, for example, broadcasted roughly between 500 MHz and 1.5 GHz (1500 MHz) so that it does not interfere with the broadcasts of traditional cable TV service. Client devices 3 can communicate data with the gateway 1 and receive A/V content from the gateway device 1 through the MoCA network 4 via a communication connection 8 between the devices. The communication connection 8 between the MoCA network and the client devices 3 can be, for example, a coaxial cable connection.

The router 5 communicates with the MoCA network 4 using a communication connection 11 between the devices. The communication connection 11 between the MoCA network 4 and the router 5 can also be, for example, a coaxial connection. The router 5 can be a broadband router that utilizes an Ethernet standard for wired connections for communicating with a client device 3 via connection 10. Additionally, the router 5 also incorporates wireless networking capability utilizing the Wi-Fi standards for communicating with client devices 3 using a wireless communication connection 9. The client devices 3 connected to the MoCA network 4 and the router 5 may include, but is not limited to, a television, a computer, a portable device, an electronic tablet, a smart phone and other consumer electronic device capable to executing and displaying A/V content received from the gateway device 1.

The gateway device 1, router 5, and client devices 3 include a combination of similar hardware and software that enables the devices to be CVP-2 (VidiPath) compatible devices. These similar hardware and software components are described with reference to the gateway device 1 of FIG. 2. VidiPath is a set of guidelines developed by the Digital Living Network Alliance (DLNA) that enables consumers to view subscription TV content on a wide variety of devices including televisions, tablets, phones, Blu-ray players, set top box, personal computers and game consoles without any additional intermediate devices from the content service providers using an open industry standard. CVP-2 (VidiPath) compatible devices can use a single protocol to enable devices to receive (i.e., stored or live-streamed) content over a DLNA home network.

FIG. 2 is a block diagram showing an exemplary gateway device for providing subscription content to one or more client devices connected in a home network according to the present invention. As shown in FIG. 2, the gateway device 1 includes a communication bus 30 through which various components and circuits in the gateway device 1 are connected for communicating data there between. The gateway device 1 includes components and circuits for receiving, decoding, storing, converting, and outputting the A/V content to the client devices 3. The components of the gateway 1 include a controller 20, a random access memory (RAM) 21, a non-volatile memory 22, a transcoder 23, a user interface 24, an A/V input/output circuit 25, a tuner 26, an A/V decoder 27, a Wi-Fi transceiver 28, and an Infrared (IR) receiver 29.

The controller 20 may be a dedicated controller, CPU, microprocessor, etc., capable of controlling the operation of the components and circuits of the gateway device 1. The RAM 21 may be implemented as a working memory for the controller 20, and the non-volatile memory 22 can be provided for storage of program code or software, A/V content, client device format capability information, and other data. However, it is also contemplated that the RAM 21 memory can be implemented for storage of program code or software, A/V content, client device format capability information, and other data. The transcoder 23 converts data including the A/V content into a data format that is usable by the client devices 3. For example, the transcoder 23 may convert A/V content from MPEG-4/advanced audio coding (AAC) to MPEP-2/MP3. However, it is contemplated by the invention that the transcoder 23 is capable of converting the A/V content into multiple data formats so that the A/V content is usable by all client devices 3 connected in the DLNA home network.

The user interface 24 provides a means for inputting instructions directly to the gateway device 1. The user interface 24 may include, but is not limited to, keys, buttons, knobs, or other similar input devices that can be used to input instructions for controlling operations on the gateway device 1. The A/V input/output circuit 25 includes one or more connectors, such as coaxial cable connectors, RF connectors or Ethernet connectors. One of the connectors of the A/V input/output circuit 25 can be connected to a content service provider, such as a multiple system operator (MSO), by terrestrial antenna, satellite dish, or wired cable. Through this connector of the A/V input/output circuit 25, the gateway device 1 receives the A/V content from the content service provider. Additionally, one of the connectors of the A/V input/output circuit 25 can be used to send data to the content service provider.

The tuner 26 can select a desired channel from the received A/V content 24 based on the input instruction by the user either through a button or buttons of the user interface 24 on the gateway device 1 or via IR signal received from the a remote device (not shown). The signal of the selected channel is decoded by the A/V decoder 27. The A/V decoder 27 decodes the selected signal so that the A/V content is usable by the client devices 3. The A/V input/output circuit 25 can also include a connector that is to be connected to the router 5 and client devices 3 for transmitting the A/V content received by the gateway device 1 and decoded by the A/V decoder 27. Additionally, the gateway device 1 can provide the A/V content according to Internet Protocol Television (IPTV), in which the tuner 26 may be omitted.

The Wi-Fi transceiver 28 is, for example, a Wi-Fi WLAN interface radio transceiver, or an in-home LTE (Long Term Evolution) transceiver that outputs signals of the selected channel to a wireless user device. The wireless output from the Wi-Fi transceiver can be in place of or in addition to the wired output by the A/V input/output circuit 25. The A/V content from the service provider can be received by a separate electronic device, such as a cable modem, or a set-top box, and communicated to the gateway device 1 wirelessly via the Wi-Fi transceiver 28.

The IR receiver 24 communicates IR signals with a remote device (not shown), and the IR signal may include data that can be used by the controller 20 to control operations of the components and circuits of the gateway device 1. Although the remote device 22 is described as a remote control device using an IR signal or protocol, it is contemplated by the invention that other remote control devices could be implemented that use protocols such as, but not limited to, Bluetooth Audio/Video Remote Control Profile (AVRCP), RF4CE, ZigBee, Wi-Fi, and Z-Wave. Similarly, the gateway device 1 is described as implementing the use of an IR receiver 24, it is contemplated by the invention that other types of receivers could be implemented that use protocols such as, but not limited to, Bluetooth AVRCP, RF4CE, ZigBee, Wi-Fi, and Z-Wave.

The RAM 21 and/or the non-volatile memory 22 may store program code or software for implementing communications with the router 5 and client devices 3 in accordance with CVP-2 (VidiPath) protocol. The controller 20 executing the program code or software provides information related to the A/V content as well as the A/V received and stored by the gateway device 1 and received by the content service provider. The information related to the A/V content may include content entries published as part of a CDS, which contains a list of URIs to the content (e.g., channels/live or recorded content) available from the gateway device 1. The information related to the A/V content may also include data format capability information received in an HTTP GET and HEAD request transmitted between the gateway device 1 and client devices 3.

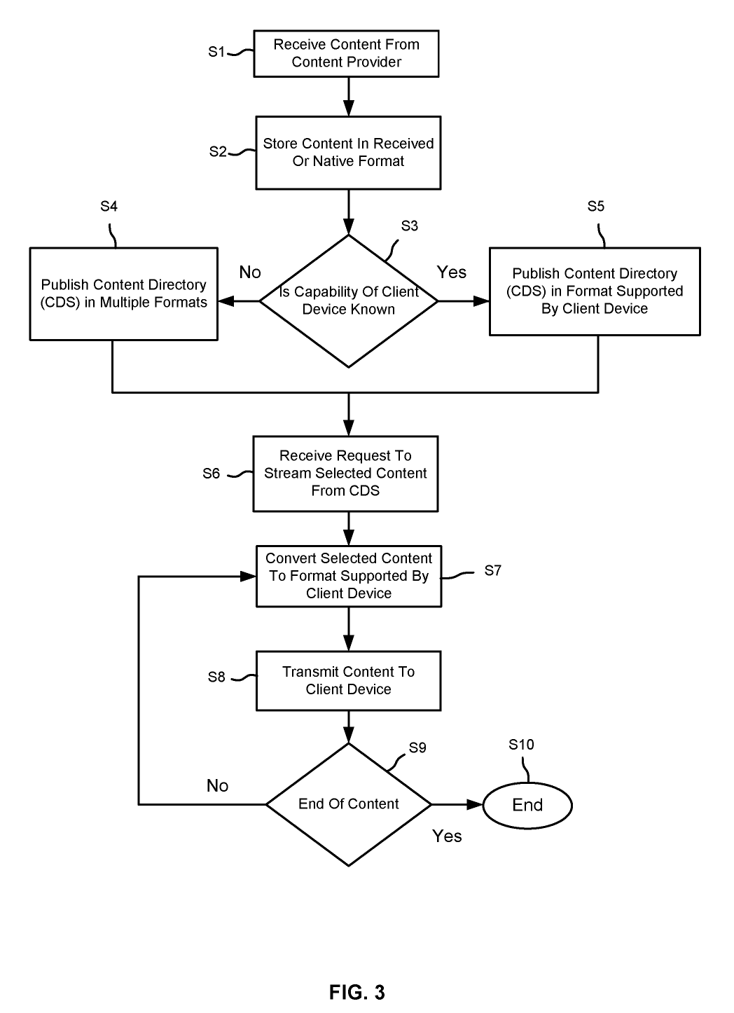

FIG. 3 is flow chart showing an exemplary algorithm and method for providing subscription content to one or more client devices connected in a home network according to the present invention. The algorithm and method shown in FIG. 3 can be implemented in the exemplary system and gateway device 1 shown respectively in FIGS. 1 and 2. For example, the method and algorithm can be implemented by a program stored in the RAM 21 or the non-volatile memory 22 and executed by the controller 20, such that the controller 20 controls the operations of the components and circuits of the gateway device 1 to perform operations of the method and algorithm.

Although the detailed operation of the components and circuits of the gateway device 1 have already been described in detail with reference to FIG. 2, the method and algorithm for providing subscription content to one or more client devices connected in a home network will be described with reference to some of the elements in FIGS. 1 and 2.

As shown in FIG. 3, the input/output circuit 25 of the gateway device 1 receives A/V content from a content service provider in step S1. The content service provider includes, for example, a cable television provider, a satellite television provider, an internet service provider, and multiple system operators; and the A/V content may include television programming and movies. In step S2, the A/V content received from the content service provider is stored in either the RAM 21 or non-volatile memory 22 of the gateway device 1 in the received native data format. For example, if the A/V content is received in MPEG-2/MP3 data format from the content service provider, the A/V content is stored in the RAM 21 or non-volatile memory 22 of the gateway device 1 in the same MPEG-2/MP3 data format.

In step S3, the controller 20 determines if the data format capability of the client devices 3 is known based on data stored the RAM 21 or non-volatile memory 22. The data format capability information may be received in an HTTP GET and HEAD request transmitted between the gateway device 1 and the client devices 3, and subsequently stored in the RAM 21 or non-volatile memory 22 of the gateway device 1. The GET and HEAD requests are used as part of an HTTP protocol such as HTTP 1.1 and are used as a method of retrieving information from a given device using a given URI.

In step S4, if the controller 20 determines that data format capability of a client device 3 is not known, then the controller 20 controls the input/output circuit 25 to publish the CDS for display by the client device 3 in multiple data formats. Using the DLNA or CVP-2 (i.e., VidiPath) standard, the gateway device 1, publishes the CDS that includes content entries for tunable channels and media content for use by the client devices 3. The transcoder 23 can convert the data for the CDS into the multiple data format need, wherein at least of which may be supported by the client device 3. Thus, even if the A/V content is not available in a format supported by all client devices 3, the gateway 1 will publish data as part of CDS regarding the A/V content such that it meets the format supported by all client devices 3 participating in the DLNA network.

For example, the CDS listing published by gateway device 1 to the client device 3 when the data format capability is not known can include, for example, data formats in mp4, mp2, is and 0.3gp as follows:

Main Content Directory—
Content1.mp4
Content1.mp2
Content1.ts
Content1.3gp
   As another example, if one client device 3 can only support MPEG-2 with MP3 audio, and another client device 3 can support MP4 with advanced audio coding (AAC) (e.g., assume the native data format is MP4 with AAC and the transcoder 23 of the gateway 1 can convert MP4 to MP2), the content entries of the CDS published by the gateway device 1 will contain both entries “content1.mp4 and content1.mp2.” The supported data format by the client devices 3 can be returned as part of a subsequent HTTP GET request by the client devices 3.

Alternatively, in step S3, if the controller 20 determines that the data format capability of the client devices 3 is known based on data stored the RAM 21 or non-volatile memory 22, in step S5 the controller 20 publishes the CDS for display by the client device 3 in the data format that is known to be compatible with the client device 3. For example, the CDS published by the gateway device 1 to the client device 3 when the data format capability is known to be MP2 is as follows:

Main Content Directory—
Content1.mp2
   As noted above, the data format capability information may be received in an HTTP GET and HEAD request transmitted between the gateway device 1 and the client devices 3, and subsequently stored in the RAM 21 or non-volatile memory 22 of the gateway device 1.

As another example, if the gateway device 1 comes to know about the data format capability of a client device 3 and even if that format of the A/V content is not directly supported by the client device 3, the gateway device 1 spoofs as if that format version of the A/V content is directly available by listing data in the CDS regarding the A/V content in a format supported by the client device 3. That is, a client device 3 that is DLNA/CVP-2 (Vidipath) compatible will promptly display the content on the CDS with a listing of the A/V content as if the A/V content is available.

In step S6, the input/output circuit 25 of the gateway device 1 receives a request from a client device 3 for A/V content based on a selection made from the published CDS. The client devices 3 are compatible DLNA or CVP-2 (e.g., VidiPath) game consoles, personal computers, tablets, appliances, televisions, mobile devices, etc.) that subscribe to the CDS and make a selection from the CDS for receiving live-streamed or record A/V content. The request for content from the client device 3 can be received in an HTTP GET request transmitted to gateway device 1 from the client devices 3. In step S7, once the HTTP GET request is received by the input/output circuit 25, the controller 20 controls the transcoder 23 to convert the live-steamed or stored content received from the content service provider and selected from the CDS to a data format known to be supported by the client device 3.

In step S8, the input/output circuit 25 then transmits the A/V content to the client devices in the supported data format. In step S9, the controller 20 determines if the selected A/V has been completely converted and transmitted to client device, and if not, continues to convert the live-steamed or stored content selected from the CDS and transmit the A/V content to the client device 3, as in steps S7 and S8. Once the controller 20 determines that the selected A/V has been completely converted and transmitted to client device, the process providing the selected A/V content selected from the CDS is ended in step S10.

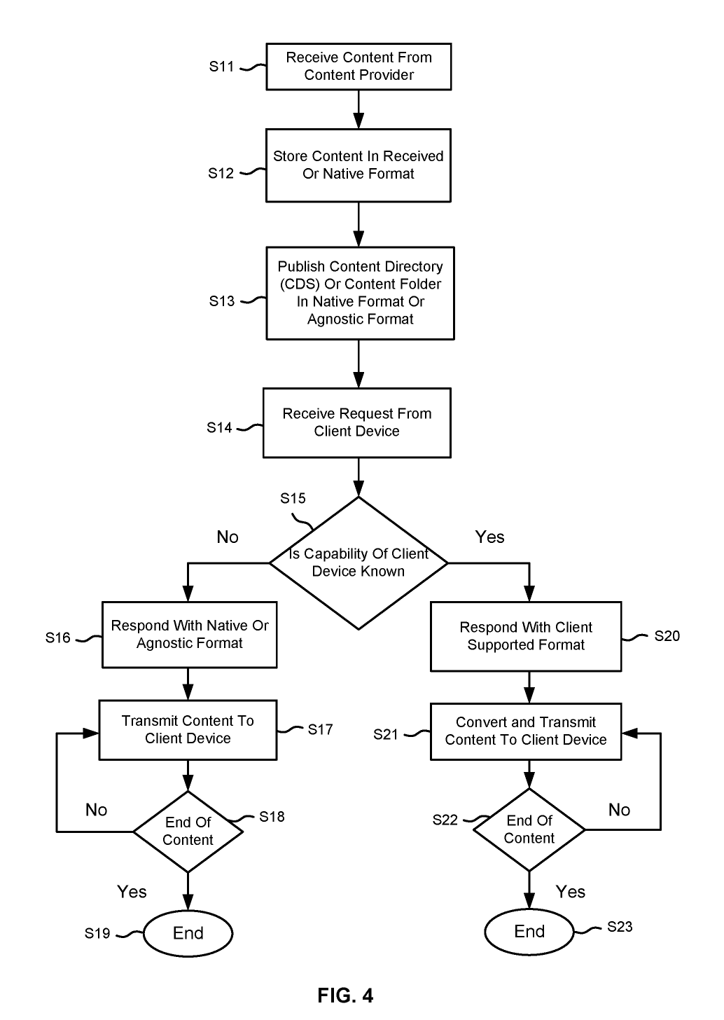

FIG. 4 is flow chart showing an exemplary algorithm and method for providing subscription content to one or more client devices connected in a home network according to the present invention. The algorithm and method shown in FIG. 4 can be implemented in the exemplary system and gateway device 1 shown respectively in FIGS. 1 and 2. For example, the method and algorithm can be implemented by a program stored in the RAM 21 or the non-volatile memory 22 and executed by the controller 20, such that the controller 20 controls the operations of the components and circuits of the gateway device 1 to perform operations of the method and algorithm. Although the detailed operation of the components and circuits of the gateway device 1 have already been described in detail with reference to FIGS. 1 and 2, the method and algorithm for providing subscription content to one or more client devices connected in a home network shown in FIG. 4 will be described with reference to some of the elements in FIGS. 1 and 2.

As shown in step S11, the input/output circuit 25 of the gateway device 1 receives A/V content from a content service provider. The content service provider includes, for example, a cable television provider, a satellite television provider, an internet service provider, and multiple system operators; and the A/V content may include television programming and movies. In step S12, the A/V content received from the content service provider is stored in either the RAM 21 or non-volatile memory 22 of the gateway device 1 in the received native data format. In step S13, the controller 20 controls the input/output circuit 25 to publish the CDS or content folder in the native data format or in an agnostic data format.

Agnostic data format refers a data format that can be supported universally by many devices, whereas the native data format is the format of the data as received by the content service provider. As part of agnsotic data format CDS publishing, the file name of the content may not have any extension. With that the clients will come to know about the data format and will present it to the user, if capable. This will allow the CDS to be compact (without many entries) and the format ill be made known to the clients only after the client issues a HTTP GET or HEAD. For example, the CDS published by the gateway device 1 to the client device 3 is as follows (note that the CDS item does not have any file extension):

Main Content Directory—
Content1

The CDS or content folder include information related to the A/V content, which contains a list of URIs to the A/V content (e.g., channels/live or recorded content) available from the gateway device 1. In step S14, the input/output circuit 25 of the gateway device 1 receives a request from a client device 3 for A/V content based on a selection made from the published CDS or content folder. The client devices 3 are compatible DLNA or CVP-2 (e.g., VidiPath) game consoles, personal computers, tablets, appliances, televisions, mobile devices, etc.) that subscribe to the CDS and make a selection from the CDS for receiving live-streamed or record A/V content. The request for content from the client device 3 through a stand HTTP HEAD and subsequent GET request transmitted to gateway device 1 and the client devices 3.

In step S15, the controller 20 determines if the data format capability of the client devices 3 is known based on data stored the RAM 21 or non-volatile memory 22. The data format capability information may be received in an HTTP GET and HEAD request transmitted between the gateway device 1 and the client devices 3, and subsequently stored in the RAM 21 or non-volatile memory 22 of the gateway device 1.

In step S15, if the controller 20 determines that the data format capability of a client device 3 is not known, then in step S16 the controller 20 will control the input/output circuit 25 to respond the client 3 in a native data format. For example, if the data format capability is not known, the gateway device 1 may respond to the client device 3 with a native format inside, for example, contentFeatures.dlna.org. as follows:

Client device request to gateway device (assuming content1.ts is published in CDS):

### HEAD/media/content1.ts HTTP/1.0

getcontentFeatures.dlna.org: 1
Response from gateway device to client device:

### HTTP/1.1 200 OK

transferMode.dlna.org: Streaming
contentFeatures.dlna.org: DLNA.ORG_PN=MPEG_TS_HD_NA_ISO
;DLNA.ORG_OP=01;DLNA.ORG_CI=0
Content-Type: video/MP2T

### Last-Modified: . . .

Alternatively, in step S15, if the controller 20 determines that the data format capability of a client device 3 is not known, then in step S16 the controller 20 will control the input/output circuit 25 to respond to the client 3 in a agnsotic data format. For example, if the data format capability is not known, the gateway device 1 may respond to the client device 3 with a agnsotic format inside, for example, contentFeatures.dlna.org. as follows:

### Client Device Request to Gateway Device (Assuming Content1 is Published in CDS and MPEG2TS is an Format More Readily Supported by Many Devices and Easy for the Gateway to Prepare):

### HEAD/media/content1 HTTP/1.0

getcontentFeatures.dlna.org: 1
Response from gateway device to client device:

### HTTP/1.1 200 OK

transferMode.dlna.org: Streaming
contentFeatures.dlna.org: DLNA.ORG_PN=MPEG_TS_HD_NA_ISO
;DLNA.ORG_OP=01;DLNA.ORG_CI=0
Content-Type: video/MP2T

### Last-Modified: . . .

With that the client will come to know about the data format and will present it to the user, if capable. This will allow the CDS to be compact and the format will be made known to the clients only after the client issue a HTTP GET or HEAD.
In step S17, the controller 20 controls the input/output circuit 25 to transmit the A/V content to the client devices 3 in the native or agnostic data format inside contentFeatures.dlna.org., as in the example noted above.

In step S18, the controller 20 determines if the A/V content has been completely transmitted to client device 3, and if not, continues to transmit the live-steamed or stored A/V content selected from the CDS to the client device 3. in step S17. Once the controller 20 determines that the A/V content has been completely transmitted to client device 3, the process of providing the A/V content selected from the CDS is ended in step S19.

In step S15, if the controller 20 determines that data format capability of a client device 3 is known, then in step S20 the controller 20 will control the input/output circuit 25 to response the client 3 in a data format supported by the client device 3. For example, a response from gateway device 1 to the client device 3, assuming that the client capability is only MPEG-2 decoding and even if the content is AAC, may indicate that the MPEG-2 video as shown below (i.e., provided the transcoder 23 of the gateway device 1 can later convert to MPEG-2 when the streaming of the A/V content starts):

### Example 1

### HTTP/1.1 200 OK

transferMode.dlna.org: Streaming
contentFeatures.dlna.org: DLNA.ORG_PN=MPEG_TS_HD_NA_ISO;
DLNA.ORG_OP=01;DLNA.ORG_CI=0
Content-Type: video/mpeg

### Last-Modified: . . .

### Example 2

A response from gateway device 1 to the client device 3, assuming that the client device 3 data format capability is only AAC decoding and even if the content is AC3, may indicate that the AAC audio as shown below (i.e., provided that the transcoder 23 of gateway device 1 can later convert to AAC when streaming of the A/V content starts):

### HTTP/1.1 200 OK

transferMode.dlna.org: Streaming
contentFeatures.dlna.org: DLNA.ORG_PN=AAC;
DLNA.ORG_OP=01;DLNA.ORG_CI=0
Content-Type: audio/x-aac

### Last-Modified: . . .

In step S21, the controller 20 controls the transcoder 23 to convert the live-steamed or stored content received from the content service provider and selected from the CDS to a data format known to be supported by the client device 3, and the controller 20 controls the input/output circuit 25 to transmit the A/V content to the client devices in the supported data format. In step S22, the controller 20 determines if the selected A/V has been completely converted and transmitted to client device 3, and if not, continues to convert the live-steamed or stored content selected from the CDS and transmit the A/V content to the client device 3, as in steps S21. Once the controller 20 determines that the selected A/V has been completely converted and transmitted to client device 3, the process providing the A/V content selected from the CDS is ended in step S23.

It is contemplated by the invention that the A/V content can be converted by the transcoder 23 of the gateway device 1 in real-time for live streaming the A/V content or converted at a later time by the trancoder 23. For example, in case the A/V content cannot be converted by the transcoder 23 in real-time, the gateway device 1 can convert the A/V content offline and can offer that A/V content in a time shifted manner, an archived manner, or in a manner indicated by the client device 3. In another embodiment, the gateway device 1 can respond to a request for A/V content with a response of “Not Available” as a standard HTTP response and can transmit the A/V content to an external service 2 for conversion of the A/V content, so that that A/V content is at least available at a later time to the client device 3. In another embodiment, the gateway device can flag or mark the content using digital rights management (DRM) understood by the client device 3 and once requested can employ DRM mutually supported by the client device, as shown in the example below.

Example: The playready (e.g., only the gateway device 1 understands and supports) can be converted to digital transmission content protection (DTCP) (e.g., client device 3 and gateway device 1 both understand and support).

As noted above, the present invention can be implemented not only as an apparatus or system, but also as a method and algorithm for providing subscription content to one or more client devices connected in a home network. The apparatus or system, method, and algorithm of the present invention provide entries in a CDS for every possible content received and/or stored by a content media server, gateway device, and set-top box to all in-home DLNA or VidiPath client devices so that even the lesser capable DLNA or VidiPath client devices can receive a complete CDS (i.e., with a full list of the tunable channels and content) and thereby receive more subscription television programming and movie content. The present invention can be implemented as a program on a non-transitory computer-readable medium for causing a computer, such as the controller gateway device 1, to execute the step described in FIGS. 3 and 4. The non-transitory computer-readable recording medium could be, for example, a CD-ROM, DVD, Blu-ray disc, or an electronic memory device.

The present invention may be implemented as any combination of a system, a method, an integrated circuit, and a computer program on a non-transitory computer readable recording medium. The controller and any other parts of the electronic apparatuses may be implemented as Integrated Circuits (IC), Application-Specific Integrated Circuits (ASIC), or Large Scale Integrated circuits (LSI), system LSI, super LSI, or ultra LSI components which perform a part or all of the functions of the electronic apparatuses, such as set-top boxes.

Each of the parts of the present invention can be implemented using many single-function components, or can be one component integrated using the technologies described above. The circuits may also be implemented as a specifically programmed general purpose processor, CPU, a specialized microprocessor such as Digital Signal Processor that can be directed by program instructions on a memory, a Field Programmable Gate Array (FPGA) that can be programmed after manufacturing, or a reconfigurable processor. Some or all of the functions may be implemented by such a processor while some or all of the functions may be implemented by circuitry in any of the forms discussed above.

The present invention may be a non-transitory computer-readable recording medium having recorded thereon a program embodying the methods/algorithms discussed above for instructing the controller to perform the methods/algorithms. Each of the elements of the present invention may be configured by implementing dedicated hardware or a software program on a memory controlling a processor to perform the functions of any of the components or combinations thereof. Any of the components may be implemented as a CPU or other processor reading and executing a software program from a recording medium such as a hard disk or a semiconductor memory.

The sequence of the steps included in the above described algorithms are exemplary, and algorithms having a sequence other than the above described sequences are contemplated. Moreover, steps, or parts of the algorithm, may be implemented simultaneously or in parallel. The components of the present invention can be in the form of a gateway device as in the exemplary embodiments disclosed above, or in other standalone devices, or may be incorporated in a television or other content playing apparatus, or other device or appliance, and the scope of the present invention is not intended to be limited on such forms. It is also contemplated that the implementation of the components of the present invention can be done with any newly arising technology that may replace any of the above implementation technologies.

1. An electronic apparatus for providing subscription content to one or more client devices connected in a home network, the electronic apparatus comprising:
an input circuit that receives audio/video (A/V) content from a content provider;
a second input circuit that receives information from the one or more client devices;
a memory for storing the A/V content received from the content provider in a native data format;
a controller that generates data for a directory customized for at least one client device based on the information received from the client devices, the directory listing information regarding the A/V content received from the content provider that can be provided in a format appropriate to the client device; and
an output circuit that publishes the directory in the native data format, an agnostic data format or a plurality of data formats, or publishes the directory in a data format known to be compatible with the one or more client devices based on the information received from the one or more client devices, the directory being used by the one or more client devices for selecting A/V content,
wherein the output circuit further outputs the A/V content received from the content provider to the one or more client devices based on a selection made from the directory.

2. The electronic apparatus according to claim 1, further comprising: a transcoder circuit that:
converts the data for the directory from the native data format of the content received from the content provider to the agnostic data format, the plurality of data formats, or the data format known to be compatible with the one or more client devices; and
converts the A/V content received from the content provider from the native data format to the data format known to be compatible with the one or more client devices.

3. The electronic apparatus according to claim 2, wherein the A/V content output to the one or more client devices is content either stored in the memory or live-streamed from the content provider.

4. The electronic apparatus according to claim 2, wherein the directory is a content directory service or program guide containing a listing of user resource identifiers (URIs) for content available from the content provider through the electronic apparatus.

5. The electronic apparatus according to claim 2, wherein the information received from the one or more client devices includes data format capability information received in an HTTP GET or HEAD request communicated between the electronic apparatus and the one or more client devices.

6. The electronic apparatus according to claim 5, wherein after receiving the HTTP GET or HEAD request from the one or more client devices, the controller controls the output circuit to output the A/V content received from the content provider in the native data format or in the data format known to be compatible with the one or more client devices.

7. The electronic apparatus according to claim 1, wherein the controller:
controls the output circuit to output the A/V content to an external server, the external server converting the A/V content from the native data format received from the content provider to the data format compatible with the one or more client devices;
controls the input circuit to receive the A/V content converted by the external server; and
controls the output circuit to output the A/V content in the data format known to be compatible with the one or more client devices.

8. The electronic apparatus according to claim 1, wherein the one or more client devices and electronic apparatus are CVP-2(VidiPath) compatible devices.

9. A method implemented on an electronic apparatus for providing subscription content to one or more client devices connected in a home network, the method comprising:
receiving, using one or more input circuits, audio/video (A/V) content from a content provider and information from the one or more client devices;
storing, using a memory, the A/V content received from the content provider in a native data format;
generating, using a controller, data for a directory customized for at least one client device based on the information received from the client devices, the directory listing information regarding the A/V content received from the content provider that can be provided in a format appropriate to the client device; and
publishing, using an output circuit, the directory in the native data format, an agnostic data format or a plurality of data formats, or publishes the directory in a data format known to be compatible with the one or more client devices based on the information received from the one or more client devices,
the directory being used by the one or more client devices for selecting A/V content,
wherein the output circuit further outputs the A/V content received from the content provider to the one or more client devices based on a selection made from the directory.

10. The method according to claim 9, further comprising:
converting, using a transcoder circuit, the data for the directory from the native data format of the content received from the content provider to the agnostic data format, the plurality of data formats, or the data format known to be compatible with the one or more client devices; and
converting, using a transcoder circuit, the A/V content received from the content provider from the native data format to the data format known to be compatible with the one or more client devices.

11. The method according to claim 10, wherein the outputting of the A/V to the one or more client devices includes outputting A/V content either stored in the memory or live-streamed from the content provider.

12. The method according to claim 10, wherein the directory is a content directory service or program guide containing a listing of user resource identifiers (URIs) for content available from the content provider through the electronic apparatus.

13. The method according to claim 10, wherein the information received from the one or more client devices includes data format capability information received in an HTTP GET or HEAD request communicated between the electronic apparatus and the one or more client devices.

14. The method according to claim 13, wherein after receiving the HTTP GET or HEAD request from the one or more client devices, controlling the output circuit to output the A/V content received from the content provider in the native data format or in the data format known to be compatible with the one or more client devices.

15. The method according to claim 9, further comprising
outputting, using the output circuit, the A/V content to an external server, the external server converting the A/V content from the native data format received from the content provider to the data format compatible with the one or more client devices;
receiving, using the input circuit, the A/V content converted by the external server; and
outputting, using the output circuit, the A/V content in the data format known to be compatible with the one or more client devices.

16. A non-transitory computer readable storage medium having stored thereon a program implemented on an electronic apparatus for providing subscription content to one or more client devices connected in a home network, the program causing the electronic apparatus to perform steps comprising:
receiving audio/video (A/V) content from a content provider and information from the one or more client devices;
storing the A/V content received from the content provider in a native data format;
generating data for a directory customized for at least one client device based on the information received from the client devices, the directory listing information regarding the A/V content received from the content provider that can be provided in a format appropriate to the client device;
publishing the directory in the native data format, an agnostic data format or a plurality of data formats, or publishing the directory in a data format known to be compatible with the one or more client devices based on the information received from the one or more client devices, the directory being used by the one or more client devices for selecting A/V content; and
outputting the A/V content received from the content provider to the one or more client devices based on a selection made from the directory.

17. The non-transitory computer readable storage medium according to claim 16, wherein the program causes the electronic apparatus to perform steps further comprising:
converting the data for the directory from the native data format of the content received from the content provider to the agnostic data format, the plurality of data formats, or the data format known to be compatible with the one or more client devices; and
converting the A/V content received from the content provider from the native data format to the data format known to be compatible with the one or more client devices.

18. The non-transitory computer readable storage medium according to claim 16, wherein the directory is a content directory service or program guide containing a listing of user resource identifiers (URIs) for content available from the content provider through the electronic apparatus.

19. The non-transitory computer readable storage medium according to claim 17, wherein the information received from the one or more client devices includes data format capability information received in an HTTP GET or HEAD request communicated between the electronic apparatus and the one or more client devices.

20. The non-transitory computer readable storage medium according to claim 18, wherein after receiving the HTTP GET or HEAD request from the one or more client devices, controlling the output circuit to output the A/V content received from the content provider in the native data format or in the data format known to be compatible with the one or more client devices.

21. The non-transitory computer readable storage medium according to claim 16, wherein the program causes the electronic apparatus to perform steps further comprising:
outputting, using the output circuit, the A/V content to an external server, the external server converting the A/V content from the native data format received from the content provider to the data format compatible with the one or more client devices;
receiving, using the input circuit, the A/V content converted by the external server; and
outputting, using the output circuit, the A/V content in the data format known to be compatible with the one or more client devices.
